(19) United States
(12) Patent Application Publication
(10) Pub. No.: US 2018/0274646 A1
(43) Pub. Date: Sep. 27, 2018

(54) FLEX SPLINE FOR STRAIN WAVE GEAR DEVICE, AND STRAIN WAVE GEAR DEVICE USING SAME

(71) Applicant: Sumitomo Riko Company Limited, Aichi (JP)

(72) Inventors: Susumu SATO, Aichi (JP); Tomohiro FUJIKAWA, Aichi (JP)

(73) Assignee: Sumitomo Riko Company Limited, Aichi (JP)

(21) Appl. No.: 15/996,534

(22) Filed: Jun. 4, 2018

Related U.S. Application Data
(63) Continuation of application No. PCT/JP2017/003121, filed on Jan. 30, 2017.

(30) Foreign Application Priority Data
Mar. 31, 2016 (JP) 2016-071910

(51) Int. Cl. F16H 49/00

(52) U.S. Cl. CPC F16H 49/001; F16H 2049/003

(57) ABSTRACT

Provided is a flex spline and a strain wave gear device using this flex spline. In this flex spline for a strain wave gear device, a cylindrical part equipped with external teeth is formed by multiple pin members adjacent to each other in the circumferential direction. The periphery of the cylindrical part is partially pressed and expanded toward the outer circumference by a wave generator and the pin members engage internal teeth of a circular spline, and at another portion of the periphery of the cylindrical part the pin members are retained by a retaining device without engaging the internal teeth of the circular spline. In addition, an output member or a securing member is attached to a first pin support member and/or a second pin support member supporting both ends of the pin members.

### CROSS-REFERENCE TO RELATED APPLICATION

The present application is a continuation of PCT/JP2017/003121, filed on Jan. 30, 2017, and is related to and claims priority from Japanese patent application no. 2016-071910 (filed on Mar. 31, 2016). The entire contents of the aforementioned application are hereby incorporated by reference herein.

### TECHNICAL FIELD

The disclosure relates to a flex spline for a strain wave gear device and a strain wave gear device using the flex spline.

### BACKGROUND ART

In the related art, for example, application of a strain wave gear device as a precise reduction gear which is used to drive a joint of a robot or the like has been studied. In general, a strain wave gear device has a structure in which a flex spline is inserted into a circular spline and a wave generator is inserted into the flex spline as described in Japanese Patent No. 5165120 (Patent Literature 1), Japanese Unexamined Patent Application Publication No. H5-26305 (Patent Literature 2), or the like. Internal teeth which are arranged in the circumferential direction are formed on an inner circumferential surface of the circular spline, and a cylindrical part is provided in the flex spline. The cylindrical part has external teeth corresponding to the internal teeth, and a number the external teeth is different from a number of the internal teeth. The external teeth are disposed on an outer circumferential surface of the cylindrical part. The cylindrical part of the flex spline is elastically bendable and deformable in a radial direction thereof. The cylindrical part is partially pressed and expanded toward an outer circumference in the circumferential direction by inserting the wave generator having an outer circumferential surface with a noncircular cross-section into the cylindrical part. The internal teeth of the circular spline and the external teeth of the flex spline engage with each other in the part of the cylindrical part pressed and expanded by the wave generator.

By rotating the wave generator according to an input from a motor or the like in a state in which one of the circular spline and the flex spline is fixed and sequentially moving the engagement position between the internal teeth and the external teeth in the circumferential direction, a rotational output which has been reduced depending on a difference between the number of external teeth and the number of internal teeth is acquired from the other of the circular spline and the flex spline.

Since the cylindrical part is repeatedly bent and deformed by the wave generator, the flex spline of the strain wave gear device described in Patent Literatures 1 and 2 can be deformed by a relatively small input and requires high durability against repeated inputs. Therefore, the flex spline according to the related art is generally formed of a metal such as nickel-molybdenum steel having excellent toughness.

However, in order to facilitate elastic bending deformation of the cylindrical part in a flex spline formed of nickel-molybdenum steel having excellent strength, it is necessary to set the thickness of the cylindrical part to be very small. Accordingly, regarding a current flex spline of a strain wave gear device, since it is difficult to manufacture the flex spline by using a die molding or the like which enables simple mass production and it is necessary to perform a cutting on a forging material with high precision, there is a problem in that it is very difficult to manufacture the flex spline and the flex spline is very expensive.

In a strain wave gear device including a cup-shaped flex spline described in Patent Literatures 1 and 2, since the wave generator is inserted into the flex spline, a rotational output is output from a position which is shifted to a lower side of the flex spline when the rotational output is extracted from the flex spline. Accordingly, when the strain wave gear device is applied to driving of a joint of a robot, or the like, a decrease in size of the joint may be hindered and vibrations may be generated. When the flex spline is fixed and a rotational output is extracted from the circular spline, it is necessary to support the flex spline on the lower side in a cantilever manner. Thus, there is a problem in that it is difficult to guarantee durability and an increase in size of the device may be caused.

### CITATION LIST

### Patent Literature

Patent Literature 1: Japanese Patent No. 5165120

Patent Literature 2: Japanese Unexamined Patent Application Publication No. H5-26305

### SUMMARY

### Technical Problem

The disclosure is made in consideration of the above-mentioned circumstances and provides a flex spline with a novel structure in which a target rotational output can be obtained with excellent durability or reliability and a method of extracting a rotational output can be selected with a higher degree of freedom, and a strain wave gear device using the flex spline.

### Solution to Problem

Aspects of the disclosure for achieving the above-mentioned contents will be described below. Elements which are employed in the aspects described below can be employed in an arbitrary combination as much as possible.

That is, according to a first aspect of the disclosure, there is provided a flex spline for a strain wave gear device, including: a cylindrical part that is inserted into a circular spline with an annular shape, and the circular spline having a plurality of internal teeth arranged in a circumferential direction on an internal circumferential surface of the circular spline, a plurality of external teeth are arranged in the circumferential direction and formed on an outer circumferential surface of the cylindrical part, and a number of the external teeth being different from a number of the internal teeth, the cylindrical part is partially pressed and expanded toward an outer circumference in the circumferential direction by a wave generator which is inserted into the cylindrical pail, such that the external teeth of the cylindrical part partially engage with the internal teeth of the circular spline in the circumferential direction, wherein the cylindrical part provided with the external teeth includes a plurality of pin members that are arranged in the circumferential direction, and a retaining device is provided to retain the pin members on an outer circumferential surface of the wave generator, the cylindrical part is partially pressed and expanded toward the outer circumference in the circumferential direction by the wave generator such that the pin members engage with the internal teeth of the circular spline, and the pin members in another part in the circumferential direction of the cylindrical part do not engage with the internal teeth of the circular spline and are retained at positions separated toward an inner circumference by the retaining device, a first pin support member and a second pin support member that support ends on both sides of the plurality of pin members are provided, and one of an output member that rotates along with the flex spline and a securing member that inhibits rotation of the flex spline is attached to at least one of the first pin support member and the second pin support member.

In the flex spline for a strain wave gear device having the structure according to the first aspect, the cylindrical part including the external teeth is constituted by a plurality of pin members that are arranged in the circumferential direction, and the pin members engage with the internal teeth of the circular spline. In this way, by employing the structure in which the cylindrical part including the external teeth is constituted by the plurality of pin members that are arranged in the circumferential direction, it is possible to realize partial engagement with the internal teeth in the circumferential direction using the cylindrical part which can be simply acquired without performing precise shaping by cutting and to achieve excellent durability.

In the plurality of pin members that are arranged in the circumferential direction of the cylindrical part, the ends on one side are supported by the first pin support member and the ends on the other side are supported by the second pin support member. By supporting both ends of the pin members in this way, it is possible to stably generate movement, deformation, or the like of the pin members in response to an input, and to achieve stabilization of operation of the pin members, for example, when the pin members are pressed and expanded toward the outer circumference by the wave generator. Furthermore, by receiving an external force acting on the pin members at both ends of the pin members, it is also possible to achieve an improvement in load bearing or torque transmission efficiency.

By providing the first pin support member and the second pin support member at both ends of the pin members, one of the output member that rotates along with the flex spline and extracts a rotational output and the securing member that supports the flex spline in a non-rotatable manner can be attached to at least one of the first pin support member and the second pin support member. Accordingly, with the flex spline according to this aspect, it is possible to easily cope with the arrangement or structure of the output member or the securing member. Furthermore, by attaching the output member to both ends of the cylindrical part, it is possible to obtain a rotational output from both ends of the cylindrical part and by attaching the securing member to both ends of the cylindrical part, stable support, an improvement in durability, or the like of the flex spline is achieved.

A second aspect of the disclosure provides the flex spline for the strain wave gear device according to the first aspect, wherein a pin-insertion recessed portion that is open at an opposing surface is formed in the first pin support member and the second pin support member which are arranged to face each other in an axial direction of the pin members, both ends of each pin member are inserted into the pin-insertion recessed portion of the first pin support member and the pin-insertion recessed portion of the second pin support member, both ends of each pin member are locked with respect to inner circumferential surfaces of the pin-insertion recessed portions in the circumferential direction of the cylindrical part, and both ends of each pin member is allowed to move in a radial direction of the cylindrical part in the pin-insertion recessed portions.

According to the second aspect, since both ends of the pin members are locked to the inner circumferential surface of the pin-insertion recessed portions in the circumferential direction of the cylindrical part, a force acting on the pin members due to the external teeth formed of the pin members engaging with the internal teeth of the circular spline is efficiently transmitted to the first pin support member and the second pin support member by locking of both ends of the pin members to the inner circumferential surface of the pin-insertion recessed portions.

By allowing the pin members to move in the radial direction of the cylindrical part in the pin-insertion recessed portions, the cylindrical part is partially pressed and expanded in the circumferential direction by the wave generator and the pin members partially engage with the internal teeth of the circular spline in the circumferential direction. In this way, since the pin members are separate from the first pin support member and the second pin support member and the pin members are movable relative to the first pin support member and the second pin support member in the radial direction of the cylindrical part, the partial pressing and expanding of the cylindrical part in the circumferential direction by the wave generator can be easily generated, and a large area in which the pin members engage with the internal teeth by the pressing and expanding can be obtained.

A third aspect of the disclosure provides the flex spline for the strain wave gear device according to the second aspect, wherein the pin-insertion recessed portions are formed to be continuous in the circumferential direction of the cylindrical part, a deep portion and a shallow portion are disposed in each pin-insertion recessed portion, the deep portion of the pin-insertion recessed portion in the first pin support member and the shallow portion of the pin-insertion recessed portion in the second pin support member face each other in the axial direction, the shallow portion of the pin-insertion recessed portion in the first pin support member and the deep portion of the pin-insertion recessed portion in the second pin support member face each other in the axial direction.

According to the third aspect, since a stepped portion is formed between the deep portion and the shallow portion in the pin-insertion recessed portions, the outer circumferential surface of the end of the pin member inserted into the deep portion of the pin-insertion recessed portion is brought into contact with and locked to the stepped portion in the circumferential direction of the cylindrical part and thus a force in the circumferential direction is efficiently transmitted from the pin member to the first pin support member and the second pin support member. Therefore, a reaction force of a rotational output is applied to the securing member by attaching the securing member, which supports the flex spline in a non-rotatable manner, to at least one of the first pin support member and the second pin support member, and the rotational output is applied to the output member by attaching the output member, which transmits the rotational output, to at least one thereof.

A fourth aspect of the disclosure provides the flex spline for the strain wave gear device according to any one of the first to third aspects, wherein the retaining device that elastically retains the pin members on the outer circumferential surface of the wave generator is formed in an annular shape, and the retaining device is externally fitted to the cylindrical part including the plurality of pin members.

According to the fourth aspect, the pressing and expanding of the cylindrical part by the wave generator and restoration and retainment from the pressed and expanded state can be easily achieved by elasticity of the retaining device that is formed of, for example, rubber, a polymeric elastomer, or spring steel. Furthermore, by externally fitting an annular elastic body to a portion constituted by the pin members of the cylindrical part, the pin members are easily retained at the positions along the outer circumferential surface of the wave generator.

A fifth aspect of the disclosure provides the flex spline for the strain wave gear device according to any one of first to fourth aspects, wherein the pin members and at least one of the first pin support member and the second pin support member are formed of a synthetic resin.

According to the fifth aspect, by forming at least a part of the flex spline, which was formed of a metal in the related art, out of a synthetic resin, a decrease in weight and manufacturing facilitation are achieved. In addition, the pin members, the first pin support member, and the second pin support member have lower requirements for accuracy in shape and dimension than that of the flex spline in the related art and can be simply formed by injection molding or the like.

A sixth aspect of the disclosure provides the flex spline for the strain wave gear device according to any one of the first to fifth aspects, wherein both of the first pin support member and the second pin support member are attached to one of the output member that transmits a rotational output of a member attached thereto and the securing member that inhibits rotation of the member attached thereto.

According to the sixth aspect, by attaching both of the first pin support member and the second pin support member to the output members, it is possible to extract the rotational output from both sides in the axial direction of the flex spline. On the other hand, by attaching both of the first pin support member and the second pin support member to the securing members, both sides in the axial direction of the flex spline can be supported. Accordingly, in comparison with a case in which only one side is supported, it is possible to achieve an improvement in durability and to support a reaction force of a larger rotational output.

A seventh aspect of the disclosure provides a strain wave gear device comprising: a circular spline with an annular shape in which internal teeth are formed on an inner circumferential surface of the circular spline, a cylindrical part of a flex spline inserted into an inner circumference of the circular spline, external teeth formed on an outer circumferential surface of the cylindrical part of the flex spline, and a number of the external teeth being different from a number of the internal teeth of the circular spline, a wave generator inserted into an inner circumference of the flex spline, the cylindrical part of the flex spline partially pressed and expanded toward the outer circumference in the circumferential direction by the wave generator such that the external teeth of a part pressed and expanded by the wave generator engage with the internal teeth of the circular spline, wherein the flex spline according to any one of the first to sixth aspects is used as the flex spline.

With the strain wave gear device having the structure according to the seventh aspect, compared to the flex spline in the strain wave gear device according to the related art, which was difficult and expensive to manufacture, a flex spline can be simply manufactured at a low cost by employing the structure according to the disclosure and thus it is possible to manufacture and provide a strain wave gear device more simply at a lower cost.

Furthermore, since a target rotational output can be extracted or a reaction force of a rotational output can be received on both sides of the flex spline, it is possible to improve a degree of freedom in design of a transmission mechanism of a rotational output, a support mechanism that inhibits rotation of the flex spline, or the like and to realize highly reliable operation at the time of extracting a rotational output.

### Effect of the Invention

According to the disclosure, since the cylindrical part including external teeth is constituted by a plurality of pin members that are arranged and supported in the circumferential direction, it is not necessary to shape the cylindrical part with high precision by cutting unlike the flex spline in the related art and it is possible to simply obtain the flex spline. Since the first pin support member and the second pin support member are attached to both ends of the plurality of pin members of the cylindrical part, the plurality of pin members are stably supported by the first pin support member and the second pin support member. Since transmission of a rotational output from the flex spline to another member or inhibition of rotation of the flex spline can be selectively realized by at least one of the first pin support member and the second pin support member, it is possible to easily cope with a transmission mechanism of a rotational output or a rotation inhibiting mechanism of the flex spline having various structures.

### BRIEF DESCRIPTION OF THE DRAWINGS

FIG. 1 is a perspective view of a strain wave gear device according to a first embodiment of the disclosure.

FIG. 2 is an exploded view of the strain wave gear device illustrated in FIG. 1.

FIG. 3 is a perspective sectional view of the strain wave gear device illustrated in FIG. 1.

FIG. 4 is a front view of the strain wave gear device illustrated in FIG. 1.

FIG. 5 is a sectional view taken along line V-V in FIG. 4.

FIG. 6 is a sectional view taken along line VI-VI in FIG. 4.

FIG. 7 is a perspective view of a first pin support member of the strain wave gear device illustrated in FIG. 1.

FIG. 8 is an enlarged sectional view of a principal part of the first pin support member illustrated in FIG. 7.

FIG. 9 is a perspective view of a second pin support member of the strain wave gear device illustrated in FIG. 1.

FIG. 10 is a perspective view illustrating a state in which a circular spline and some pin members are detached from the strain wave gear device illustrated in FIG. 1.

FIG. 11(a) and FIG. 11(b) are perspective views of a pin member of a strain wave gear device according to a second embodiment of the disclosure, where FIG. 11(a) illustrates a state in which an external teeth portion is not pressed by a wave generator and FIG. 11(b) illustrates a state in which the external teeth portion is pressed by the wave generator.

FIG. 12 is a perspective view of a pin member of a strain wave gear device according to a third embodiment of the disclosure.

FIG. 13 is a sectional view illustrating a principal part of a strain wave gear device according to a fourth embodiment of the disclosure.

### DESCRIPTION OF EMBODIMENTS

Hereinafter, embodiments of the disclosure will be described with reference to the accompanying drawings.

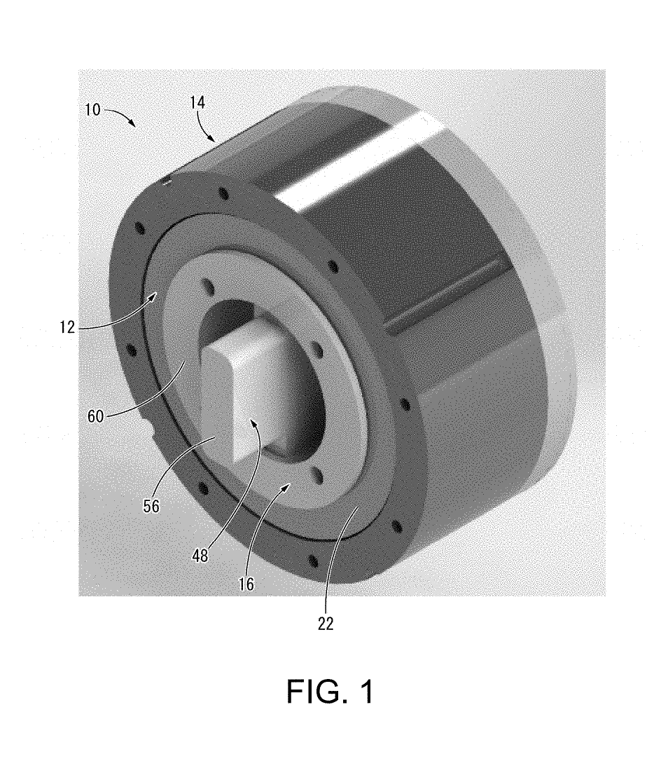

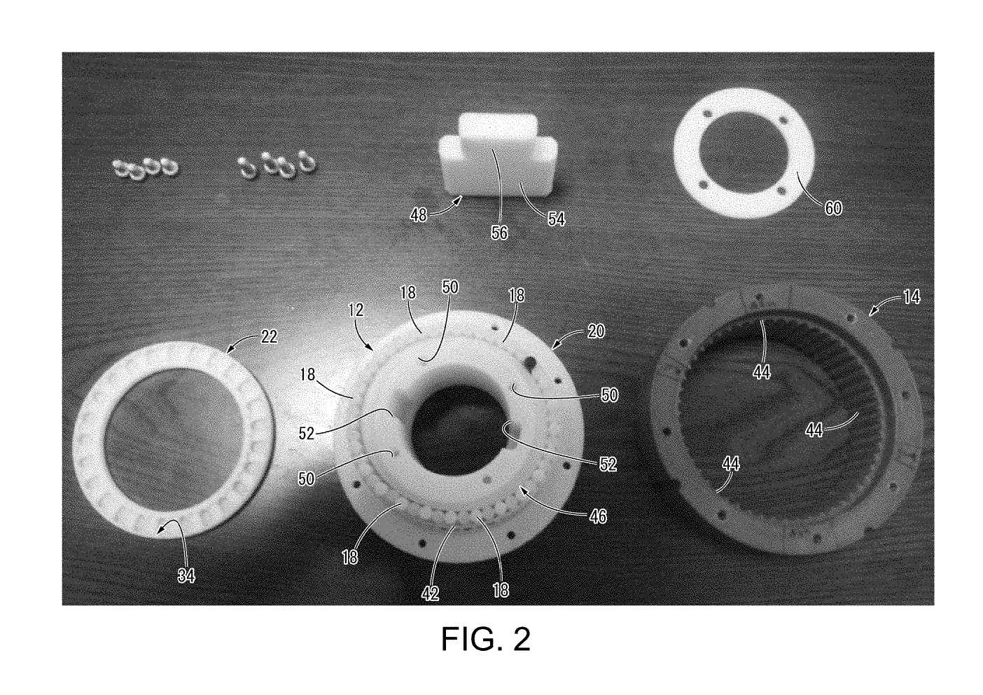

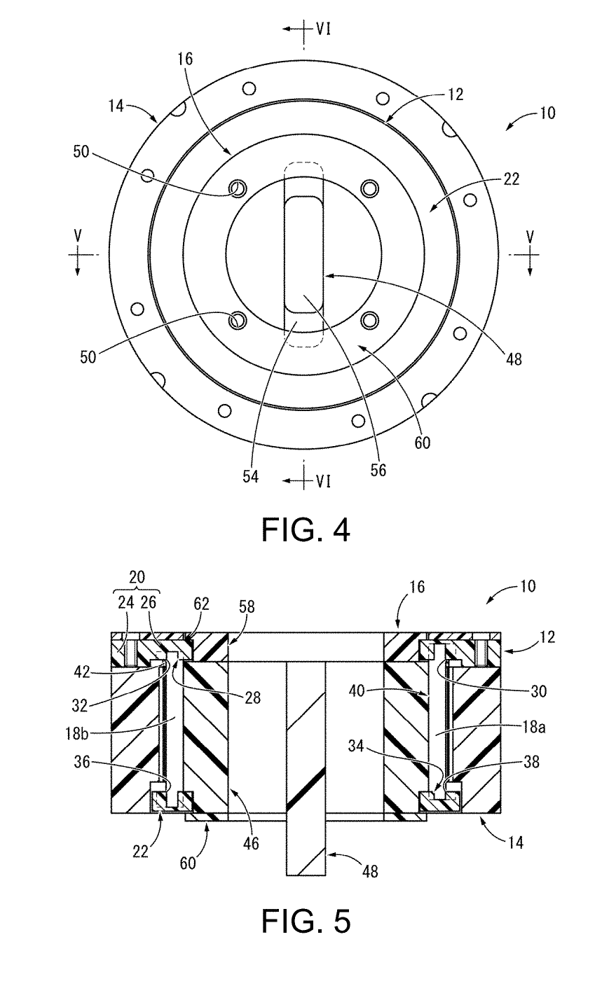

FIG. 1 illustrates a strain wave gear device 10 according to a first embodiment of the disclosure. As illustrated in FIGS. 2 to 6, the strain wave gear device 10 includes a flex spline 12, a circular spline 14, and a wave generator 16.

The flex spline 12 has a structure in which a first pin support member 20 is attached to ends on one side of a plurality of pin members 18 and a second pin support member 22 is attached to ends on the other side of the plurality of pin members 18.

The pin member 18 is a hard member formed of a synthetic resin such as an ABS resin and has a substantially cylindrical shape with a small diameter.

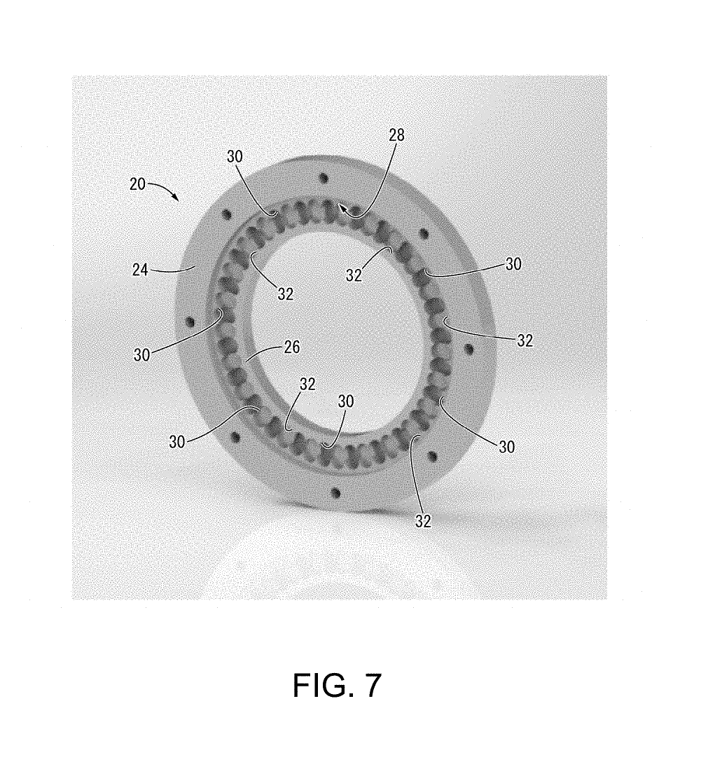

The first pin support member 20 is a hard member formed of the same synthetic resin as the pin members 18 and has a substantially annular plate shape as illustrated in FIG. 7. An outer circumferential portion 24 thereof is attached to an output member 66 which will be described later and an inner circumferential portion 26 thereof is attached to ends on one side of the pin members 18.

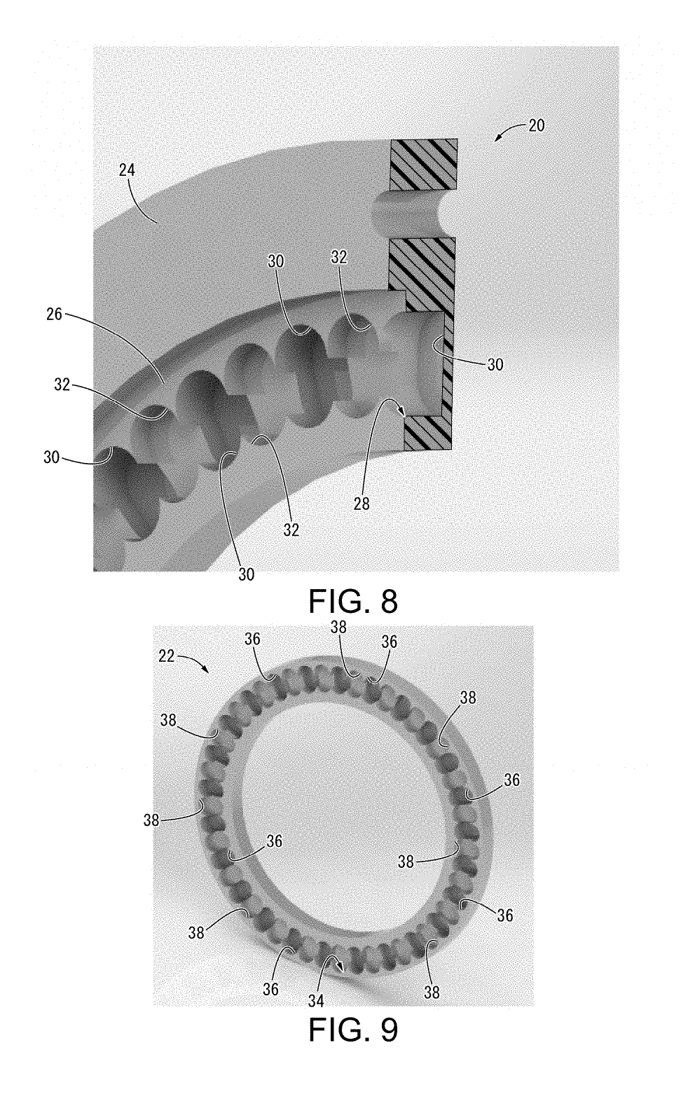

Further, a first pin-insertion recessed portion 28 with a bottom that is open at an end surface in the axial direction in the middle of the radial direction is formed in the inner circumferential portion 26 of the first pill support member 20. The first pin-insertion recessed portion 28 is formed continuous in the entire circumference in the circumferential direction, and a deep portion 30 and a shallow portion 32 are alternately provided in the circumferential direction as illustrated in FIG. 8. The deep portion 30 and the shallow portion 32 have a substantially elliptical cross-section with a long axis in the radial direction of the first pin support member 20, and a plurality of deep portions 30 and a plurality of shallow portions 32 are arranged over the entire circumference of the first pin support member 20. Moreover, by causing the deep portion 30 and the shallow portion 32 adjacent to each other in the circumferential direction of the first pin support member 20 to communicate with each other in the interface therebetween, the first pin-insertion recessed portion 28 including a plurality of deep portions 30 and a plurality of shallow portions 32 is formed continuous over the entire circumference in the inner circumferential portion 26 of the first pin support member 20. The total number of deep portions 30 and shallow portions 32 in the first pin-insertion recessed portion 28 is set to be equal to the number of pin members 18.

The second pin support member 22 is a hard member formed of the same synthetic resin as the pin members 18 and has a substantially annular plate shape as illustrated in FIG. 9. And, the second pin support member 22 has a structure corresponding to the inner circumferential portion 26 of the first pin support member 20.

Further, a second pin-insertion recessed portion 34 with a bottom that is open at an end surface in the axial direction in the middle of the radial direction is formed in the second pin support member 22. The second pin-insertion recessed portion 34 is formed continuous in the entire circumference in the circumferential direction, and a deep portion 36 and a shallow portion 38 are alternately provided in the circumferential direction. The deep portion 36 and the shallow portion 38 have a substantially elliptical cross-section with a long axis in the radial direction of the second pin support member 22, and a plurality of deep portions 36 and a plurality of shallow portions 38 are arranged over the entire circumference of the second pin support member 22. Moreover, by causing the deep portion 36 and the shallow portion 38 adjacent to each other in the circumferential direction of the second pin support member 22 to communicate with each other in the interface therebetween, the second pin-insertion recessed portion 34 including a plurality of deep portions 36 and a plurality of shallow portions 38 is formed continuous over the entire circumference in the second pin support member 22.

The second pin-insertion recessed portion 34 of the second pin support member 22 is formed in the substantially same shape and size as the first pin-insertion recessed portion 28 of the first pin support member 20. And, opening shapes of the deep portions 30 and 36 and the shallow portions 32 and 38 in the first and second pin-insertion recessed portions 28 and 34 of the first and second pin support members 20 and 22 are the same, further, the deep portions 30 of the first pin support member 20 and the shallow portions 38 of the second pin support member 22 are set to the same number, and the shallow portions 32 of the first pin support member 20 and the deep portions 36 of the second pin support member 22 are set to the same number.

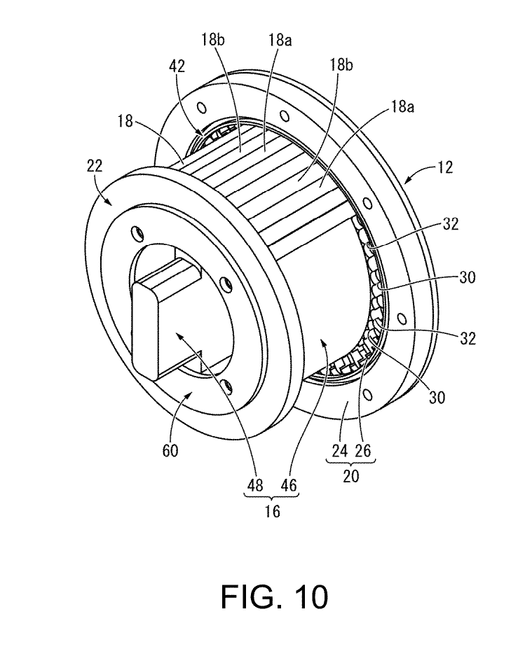

As illustrated in FIGS. 5, 6, and 10, ends on one side in the axial direction of the plurality of pin members 18 are inserted into the first pin-insertion recessed portion 28 of the first pin support member 20, the ends on one side in the axial direction of the pin members 18 are supported by the first pin support member 20, and the plurality of pin members 18 are arranged in the circumferential direction. The pin members 18 are respectively inserted into the plurality of deep portions 30 and the plurality of shallow portions 32 in the first pin-insertion recessed portion 28, and the pin members 18 inserted into the deep portions 30 and the pin members 18 inserted into the shallow portions 32 are mutually offset in the axial direction.

Besides, ends on the other side in the axial direction of the plurality of pin members 18 are inserted into the second pin-insertion recessed portion 34 of the second pin support member 22, the ends on the other side in the axial direction of the plurality of pin members 18 are supported by the second pin support member 22, and the pin members 18 are arranged in the circumferential direction. The pin members 18 are respectively inserted into the plurality of deep portions 36 and the plurality of shallow portions 38 in the second pin-insertion recessed portion 34, and the pin members 18 inserted into the deep portions 36 and the pin members 18 inserted into the shallow portions 38 are mutually offset in the axial direction.

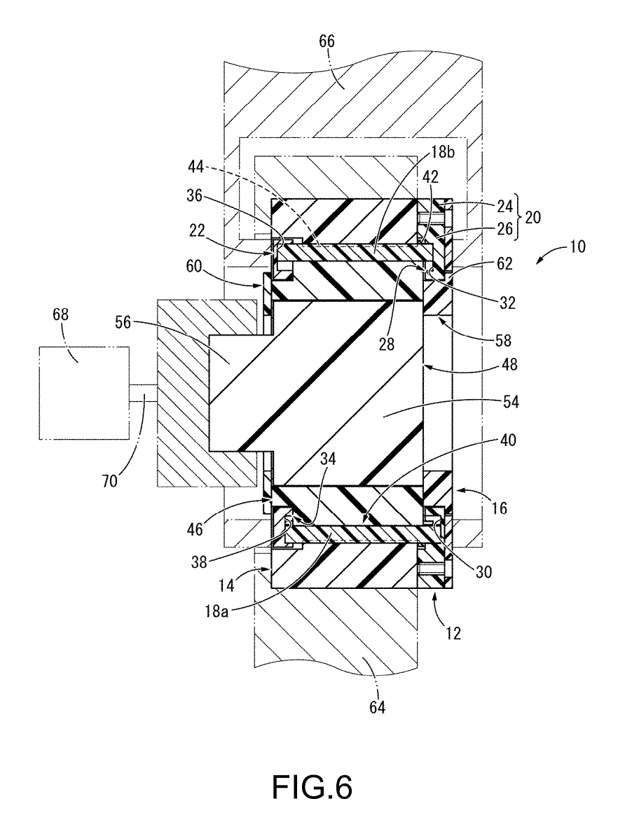

Here, the first pin support member 20 and the second pin support member 22 are disposed to oppose each other in the axial direction, and the first pin-insertion recessed portion 28 and the second pin-insertion recessed portion 34 are opened to face each other in the axial direction. Further, the positions in the circumferential direction of the first pin support member 20 and the second pin support member 22 are determined relative to each other, the deep portions 30 of the first pin-insertion recessed portion 28 and the shallow portions 38 of the second pin-insertion recessed portion 34 oppose each other in the axial direction, and the shallow portions 32 of the first pin-insertion recessed portion 28 and the deep portions 36 of the second pin-insertion recessed portion 34 oppose each other in the axial direction. Accordingly, as illustrated in FIGS. 5 and 6, pin members 18a disposed between the deep portions 30 of the first pin-insertion recessed portion 28 and the shallow portions 38 of the second pin-insertion recessed portion 34 facing each other and pin members 18b disposed between the shallow portions 32 of the first pin-insertion recessed portion 28 and the deep portions 36 of the second pin-insertion recessed portion 34 facing each other are disposed at positions shifted in the axial direction.

Moreover, the end of the pin member 18a inserted into one deep portion 30 of the first pin support member 20 is locked to the shallow portion 32 in the circumferential direction of the first pin support member 20, and the end on one side of the pin member 18a is locked to the inner surface of the first pin-insertion recessed portion 28 in the circumferential direction of a cylindrical part 40. Further, the end of the pin member 18b inserted into one deep portion 36 of the second pin support member 22 is locked to the shallow portion 38 in the circumferential direction of the second pin support member 22, and the end on the other side of the pin member 18b is locked to the inner surface of the second pin-insertion recessed portion 34 in the circumferential direction of the cylindrical part 40.

Besides, since each pin member 18 has a circular cross-section and the first pin-insertion recessed portion 28 and the second pin-insertion recessed portion 34 have an elliptical cross-section, the pin member 18 is movable relative to the first and second pin support members 20 and 22 in the radial direction of the first and second pin support members 20 and 22 which is the long axis direction of the openings of the first pin-insertion recessed portion 28 and the second pin-insertion recessed portion 34. Further, the moving distance of each pin member 18 is restricted depending on the sizes and shapes of the first pin-insertion recessed portion 28 and the second pin-insertion recessed portion 34.

And, since a plurality of (50 pieces in this embodiment) pin members 18 are arranged in the circumferential direction in a state in which the ends on both sides in the axial direction thereof are supported by the first and second pin support members 20 and 22, the cylindrical part 40 is constituted by portions of the pin members 18 protruding from the first and second pin-insertion recessed portions 28 and 34 of the first and second pin support members 20 and 22. Since the cylindrical part 40 is constituted by a plurality of pin members 18, unevenness which is arranged in the circumferential direction along the sectional shapes of the pin members 18 is formed on the outer circumferential surface and the external teeth are formed by the outer portions of the pin members 18 constituting the outer circumferential surface of the cylindrical part 40. In brief, in the flex spline 12, the cylindrical part 40 having the external teeth on the outer circumferential surface thereof is constituted by a plurality of pin members 18 that are arranged in the circumferential direction. The external teeth in this embodiment have a tooth surface which is substantially semi-cylindrical and are arranged in the circumferential direction, but the external teeth are not limited to the semi-cylindrical shape and may have a polygonal prism shape or the like depending on the shape of the pin members 18.

And, an elastic retainer member 42 as a retaining device is attached to the cylindrical part 40. The elastic retainer member 42 is formed in an annular shape of an elastic material such as rubber or elastomer, and is externally fitted to the end on the first pin support member 20 side of the cylindrical part 40 constituted by a plurality of pin members 18. Further, the inner diameter of the elastic retainer member 42 is set to be slightly smaller than the outer diameter of the cylindrical part 40 when the pin members 18 are disposed at the inner circumference ends of the first and second pin-insertion recessed portions 28 and 34, and an elastic energizing force in toward the inner circumference is normally applied to the cylindrical part 40 by externally fitting the elastic retainer member 42 to the cylindrical part 40.

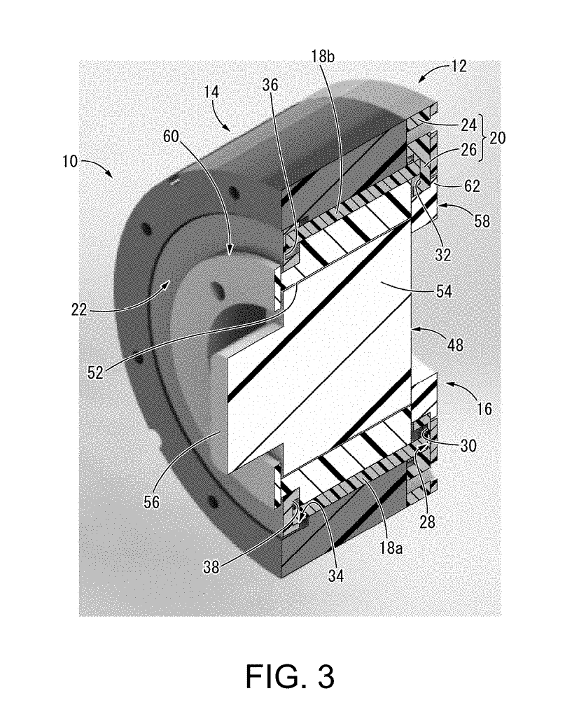

As illustrated in FIGS. 3, 5, and 6, the circular spline 14 and the wave generator 16 are assembled into the flex spline 12 having the above-mentioned structure.

The circular spline 14 is a hard member formed of a synthetic resin or a metal and has a substantially cylindrical shape or annular shape, and internal teeth 44 having a shape corresponding to the pin members 18 of the flex spline 12 are formed on the inner circumferential surface thereof. The number of internal teeth 44 is different from the number of pin members 18 constituting the external teeth, the number of internal teeth 44 is larger by an integer multiple of the number of lobes (the number of long axes of the wave generator 16 which will be described later) than the number of pin members 18, and 52 pieces of internal teeth 44 are arranged in the circumferential direction in this embodiment.

And, the cylindrical part 40 of the flex spline 12 is inserted into the inner circumference of the circular spline 14. Further, the first pin support member 20 is disposed outside in the axial direction of the circular spline 14, and the outer circumferential portion 24 of the first pin support member 20 is set to be rotationally deformable in the circumferential direction relative to the end surface in the axial direction of the circular spline 14. Moreover, in the circular spline 14 in this embodiment, the internal teeth 44 is shifted to the first pin support member 20 side, the second pin support member 22 side has a larger diameter than the internal teeth 44, and the second pin support member 22 is inserted into the larger-diameter portion in a rotationally deformable manner.

As illustrated in FIGS. 3, 5, and 6, the wave generator 16 includes a pressing cylindrical member 46 having a cylindrical shape and an input shaft member 48 having a plate shape which is inserted into the pressing cylindrical member 46.

The pressing cylindrical member 46 is a hard member formed of a synthetic resin or a metal, has a cylindrical shape as a whole, and screw holes 50 penetrating the pressing cylindrical member 46 in the axial direction are formed at a plurality of positions in the circumferential direction and are opened at both end surfaces in the axial direction. The inner circumferential surface of the pressing cylindrical member 46 has a substantially cylindrical shape as a whole, locking grooves 52 and 52 that are open to the inner circumferential surface of the pressing cylindrical member 46 and extends in the axial direction are formed in portions opposing each other in the radial direction, and the inner diameter of the pressing cylindrical member 46 is set to be partially greater in the portions in which the locking grooves 52 and 52 are formed.

Further, the outer circumferential surface of the pressing cylindrical member 46 has an elliptical cylindrical shape or a long cylindrical shape. The outer diameter in the short axis direction of the pressing cylindrical member 46 is set to be substantially equal to or slightly smaller than a minimum inner diameter of the cylindrical part 40 in which the pin members 18 are located at the inner circumferential ends of the first and second pin-insertion recessed portions 28 and 34, and the outer diameter in the long axis direction of the pressing cylindrical member 46 is set to be greater than the minimum inner diameter of the cylindrical part 40.

The input shaft member 48 has a plate shape and includes an insertion portion 54 with a large width and an input portion 56 with a small width. The input shaft member 48 has the substantially same thickness as the width of the locking grooves 52 and 52 of the pressing cylindrical member 46, and both ends in the width direction of the insertion portion 54 are inserted into the locking grooves 52 and 52 of the pressing cylindrical member 46. And, the input shaft member 48 is not limited to the plate shape and may have, for example, a cylindrical shape or a columnar shape which can be inserted into the central hole of the pressing cylindrical member 46, and a structure in which protrusions which are inserted and locked to the locking grooves 52 and 52 of the pressing cylindrical member 46 are provided on the outer circumferential surface may be employed.

As illustrated in FIG. 6, the input shaft member 48 is retained in the pressing cylindrical member 46 without being dropped therefrom by attaching a first stopper member 58 to one end surface in the axial direction of the pressing cylindrical member 46 and a second stopper member 60 to the other end surface in the axial direction of the pressing cylindrical member 46. The first stopper member 58 has a substantially annular shape, the inner diameter thereof is set to be substantially equal to the inner diameter of portions protruding from the locking grooves 52 and 52 of the pressing cylindrical member 46, and the openings on one side in the axial direction of the locking grooves 52 and 52 are blocked by the first stopper member 58 by fixing the first stopper member 58 using a screw (not illustrated) which is screwed to the screw hole 50 to overlap the end surface in the axial direction of the pressing cylindrical member 46. On the other hand, the second stopper member 60 has a substantially annular plate shape, the inner diameter thereof is set to be substantially equal to the inner diameter of the first stopper member 58, and the openings on the other side in the axial direction of the locking grooves 52 and 52 are blocked by the second stopper member 60 by fixing the second stopper member 60 using a screw (not illustrated) which is screwed to the screw hole 50 to overlap the end surface in the axial direction of the pressing cylindrical member 46. By blocking the openings on both sides in the axial direction of the locking grooves 52 and 52 with the first and second stopper members 58 and 60 in this way, the input shaft member 48 is positioned between the first and second stopper members 58 and 60 facing each other, and the input shaft member 48 is retained in a state in which it is assembled into the pressing cylindrical member 46.

The specific structure of the wave generator 16 in this embodiment is only an example and the structure of the wave generator can be appropriately modified. That is, a wave generator having a structure in which the pressing cylindrical member 46 is provided and the input shaft member 48 is omitted may be employed and a rotation shaft 70 of an electric motor 68 which will be described later may be connected to the pressing cylindrical member 46. Moreover, for example, a columnar wave generator including an outer circumferential surface with a substantially elliptical cylindrical shape or a long cylindrical shape may be employed.

And, the wave generator 16 is inserted into the flex spline 12. That is, the large-diameter portion of the pressing cylindrical member 46 in the wave generator 16 is inserted into the inner circumference of the cylindrical part 40 of the flex spline 12. Further, the pin members 18 constituting the cylindrical part 40 are energized toward the inner circumference by the elastic retainer member 42, are elastically retained in a state in which the pin members are pressed against the outer circumferential surface of the large-diameter portion of the pressing cylindrical member 46, and are arranged along the outer circumferential surface of the pressing cylindrical member 46. And, in this embodiment, all the pin members 18 are brought into contact with and retained in the outer circumferential surface of the pressing cylindrical member 46, but the pin members 18 located on both sides in the short axis direction of the pressing cylindrical member 46 (both right and left sides in FIG. 5) may be retained separated from the outer circumferential surface of the pressing cylindrical member 46 as long as the pin members 18 located on both sides in the long axis direction of the pressing cylindrical member 46 (both upper and lower sides in FIG. 6) come into contact with the outer circumferential surface of the pressing cylindrical member 46. As can be apparently seen from this point, the retaining device (the elastic retainer member 42) does not need to bring the pin members 18 into contact with the outer circumferential surface of the wave generator 16 (the outer circumferential surface of the pressing cylindrical member 46) over the entire circumference.

And, the first stopper member 58 of the wave generator 16 is inserted into the first pin support member 20 and a protrusion 62 formed in the first stopper member 58 is disposed outside in the axial direction of the first pin support member 20. Accordingly, the first pin support member 20 is permitted in rotation relative to the wave generator 16 and is positioned in the axial direction and the direction perpendicular to the axial direction.

Moreover, the small-diameter portion of the pressing cylindrical member 46 of the wave generator 16 is inserted into the inner circumference of the second pin support member 22 of the flex spline 12, and the outer circumferential end of the second stopper member 60 of the wave generator 16 is disposed outside in the axial direction of the second pin support member 22. Accordingly, the second pin support member 22 is permitted in rotation relative to the wave generator 16 and is positioned in the axial direction and the direction perpendicular to the axial direction.

Although not clearly illustrated in the drawings, it is preferable that relative displacements in the axial direction of the circular spline 14, the wave generator 16, and the flex spline 12 are limited. Above all, for example, when a securing member 64 (which will be described later) that is attached to the circular spline 14 and an output member 66 (which will he described later) that is attached to the flex spline 12 are positioned in the axial direction of the strain wave gear device 10, or the like, the circular spline 14, the flex spline 12, and the wave generator 16 may not have a structure for limiting the relative displacements thereof in the axial direction.

In the strain wave gear device 10 having the above-mentioned structure, the outer circumferential surface in the long axis direction of the pressing cylindrical member 46 (the up-down direction in FIG. 6) constituting the wave generator 16 is pressed against the inner circumferential surface of the cylindrical part 40 and the cylindrical part 40 is partially pressed and expanded toward the outer circumference in the circumferential direction. That is, a plurality of pin members 18 corning into contact with the outer circumferential surface in the long axis direction of the pressing cylindrical member 46 are pressed toward the outer circumference by the pressing cylindrical member 46 and is moved to the outer circumferential ends of the first and second pin-insertion recessed portions 28 and 34, whereby the cylindrical part 40 is partially pressed and expanded toward the outer circumference in the circumferential direction in parts in which the pin members 18 are located. In this embodiment, since the outer circumferential surface of the pressing cylindrical member 46 has an elliptical cylindrical shape or a long cylindrical shape and the number of lobes of the wave generator 16 is two, the cylindrical part 40 is pressed and expanded toward the outer circumference at two positions in the circumferential direction.

In this way, by causing the wave generator 16 to partially press and expand the cylindrical part 40 toward the outer circumference in the circumferential direction, a plurality of pin members 18 constituting the pressed and expanded parts of the cylindrical part 40 are pushed into the circular spline 14 and engage with the internal teeth 44 of the circular spline 14. In brief, among the pin members 18 arranged over the entire circumference, only a plurality of pin members 18 located at two positions in the long axis direction of the wave generator 16 are engage with the internal teeth 44. The external teeth of the cylindrical part 40 and the internal teeth 44 of the circular spline 14 are partially engaged with each other in the circumferential direction.

Further, in the short axis direction of the pressing cylindrical member 46 constituting the wave generator 16, as illustrated in FIG. 5, the cylindrical part 40 of the flex spline 12 is not pressed and expanded toward the outer circumference by the wave generator 16 but is retained along the outer circumferential surface of the wave generator 16 by the elasticity of the elastic retainer member 42. Accordingly, in the short axis direction of the pressing cylindrical member 46 of the wave generator 16, the pin members 18 are positioned separated toward the inner circumference from the internal teeth 44 of the circular spline 14, and thus engagement of the external teeth with the internal teeth 44 is avoided.

Accordingly, the pin members 18 constituting the external teeth of the flex spline 12 and the internal teeth 44 of the circular spline 14 partially engage with each other in the circumferential direction. In this embodiment, the pin members 18 and the internal teeth 44 engage with each other on both sides in the long axis direction of the wave generator 16.

In this embodiment, since the pin members 18 constituting the cylindrical part 40 are deformable in the radial direction relative to the first and second pin support members 20 and 22, the displacement of the pin members 18 toward the outer circumference can be set with a high degree of freedom. Accordingly, it is possible to cause the pin members 18 and the internal teeth 44 to engage with each other regardless of the length of the pin members 18, and thus to minimize the strain wave gear device 10 in the axial direction.

The strain wave gear device 10 having the above-mentioned structure can be made to operate, for example, as follows. That is, in the strain wave gear device 10, the circular spline 14 is attached to the securing member 64 and the flex spline 12 is attached to the output member 66, for example, as illustrated in FIG. 6. Thus, by supporting the circular spline 14 using the securing member 64 in a non-rotatable manner and causing the output member 66 to rotate along with the flex spline 12, a rotational output which has been reduced by the strain wave gear device 10 is output to the outside from the output member 66. In this embodiment, both of the first pin support member 20 and the second pin support member 22 constituting the flex spline 12 are attached to the output member 66. Further, the input shaft member 48 of the wave generator 16 is attached to the rotation shaft 70 of the electric motor 68, and the input shaft member 48 can be rotationally driven by the electric motor 68.

And, by inputting a rotational driving force of the electric motor 68 to the input shaft member 48 of the wave generator 16, the wave generator 16 is made to rotate relative to the circular spline 14. Accordingly, since the long axis direction of the wave generator 16 varies in the circumferential direction with the rotation of the wave generator 16, the positions of the pin members 18 of the flex spline 12 engaging with the internal teeth 44 of the circular spline 14 varies sequentially in the circumferential direction with the rotation of the wave generator 16. Here, since the number of pin members 18 of the flex spline 12 which constitute the external teeth is different from the number of internal teeth 44 of the circular spline 14, the flex spline 12 rotates in the direction opposite to the rotation direction of the wave generator 16 depending on the difference between the number of pin members 18 and the number of internal teeth 44 at a time point at which the wave generator 16 rotates by one turn when the pin members 18 and the internal teeth 44 engage with each other sequentially in the circumferential direction. Accordingly, an output which has been reduced at a ratio corresponding to the numbers of teeth 18 and 44 can be obtained from the flex spline 12 in response to an input to the wave generator 16. And, in this embodiment, since the number of pin members 18 as the external teeth is 50, and the number of internal teeth 44 of the circular spline 14 is 52, a reduction ratio is set to 50:2.

In this embodiment, both of the first pin support member 20 and the second pin support member 22 of the flex spline 12 are attached to the output member 66. Accordingly, since the rotational output of the flex spline 12 is applied to the output member 66 on both sides in the axial direction and a target rotational output can be obtained with good balance on both sides in the axial direction of the flex spline 12, it is possible to reduce vibration or distortion at the time of output.

Besides, the deep portions 30 of the first pin-insertion recessed portion 28 in the first pin support member 20 and the shallow portions 38 of the second pin-insertion recessed portion 34 in the second pin support member 22 face each other, and the shallow portions 32 of the first pin-insertion recessed portion 28 and the deep portions 36 of the second pin-insertion recessed portion 34 face each other. And, in the pin members 18, an end inserted into one deep portion 30 of the first pin-insertion recessed portion 28 is brought into contact with and locked to the first pin support member 20 in the circumferential direction, and an end inserted into one deep portion 36 of the second pin-insertion recessed portion 34 is brought into contact with and locked to the second pin support member 22 in the circumferential direction. Accordingly, a force in the circumferential direction applied to the pin members 18 due to engagement with the internal teeth 44 of the circular spline 14 in the flex spline 12 is efficiently transmitted to the first and second pin support members 20 and 22 and is affected as a rotational output to the output member 66. Moreover, even when a rotational output with a larger torque is generated, a force can be effectively transmitted from the pin members 18 to the first and second pin support members 20 and 22.

In the strain wave gear device 10 having the structure according to this embodiment, the cylindrical part 40 including the external teeth is constituted by a plurality of pin members 18 which are arranged in the circumferential direction. Therefore, it is possible to simply form the flex spline 12 without performing advanced cutting, to simply realize partial engagement between the external teeth (the pin members 18) and the internal teeth 44 in the circumferential direction due to movement of the pin members 18, and to obtain excellent durability.

By allowing the pin members 18 to move in the radial direction of the cylindrical part 40 in the first and second pin-insertion recessed portions 28 and 34, the cylindrical part 40 is partially pressed and expanded in the circumferential direction by the wave generator 16, and the pin members 18 of the part which has been pressed and expanded engage with the internal teeth 44 of the circular spline 14. In this way, by providing the pin members 18 separately from the first and second pin support members 20 and 22 and setting the pin members 18 to be displaceable in the radial direction of the cylindrical part 40 relative to the first and second pin support members 20 and 22, it is possible to facilitate partial pressing and expanding of the cylindrical part 40 by the wave generator 16 and to obtain a large area in which the pin members 18 and the internal teeth 44 engage with each other by the pressing and expanding.

Further, since the pin members 18 are elastically retained on the outer circumferential surface of the wave generator 16 by the elastic retainer member 42, the cylindrical part 40 is pressed and expanded against the elasticity of the elastic retainer member 42 by the wave generator 16 and restoration and retainment based on the elasticity of the elastic retainer member 42 from the pressed and expanded state can be easily realized. Moreover, the state in which the pin members 18 are elastically retained on the outer circumferential surface of the wave generator 16 is held by a simple configuration in which an annular elastic member is externally fitted to a part constituted by the pin members 18 of the cylindrical part 40.

And, since all the pin members 18 and the first and second pin support members 20 and 22 which constitute the flex spline 12 are formed of a synthetic resin, a decrease in weight and manufacturing facilitation are achieved more than a flex spline formed of a metal. Moreover, since the flex spline 12 has a structure in which the pin members 18 and the first and second pin support members 20 and 22 are combined, it is possible to set the precision in shapes and dimensions of the components to be lower than those of the flex spline with a structure according to the related art which is integrally formed as a whole and uses elasticity of a metal, and it is possible to simply form the pin members 18, the first pin support member 20, and the second pin support member 22 by injection molding or the like.

And, both ends of a plurality of pin members 18 which are arranged in the circumferential direction of the cylindrical part 40 are attached to the first pin support member 20 and the second pin support member 22, and an output can be obtained from either of the first pin support member 20 and the second pin support member 22.

Accordingly, it is possible to easily cope with various aspects in arrangement and structure of the output member 66 and to transmit the output from both sides in the axial direction of the flex spline 12 to the output member 66 as in this embodiment.

Moreover, since a force acting on the pin members 18 is transmitted from both ends of the pin members 18 to the first and second pin support members 20 and 22, it is possible to achieve improvement in load bearing and torque transmission efficiency of a rotational output, or the like. In this embodiment, the outer circumferential surface of one end of each pin member 18 is brought into contact with and locked to the stepped portion which is formed between the deep portion 30 and the shallow portion 32 of the first pin-insertion recessed portion 28 in the circumferential direction of the cylindrical part 40, and the outer circumferential surface of the other end of each pin member 18 is brought into contact with and locked to the stepped portion which is formed between the deep portion 36 and the shallow portion 38 of the second pin-insertion recessed portion 34 in the circumferential direction of the cylindrical part 40. Accordingly, it is possible to enhance transmission efficiency of a force from the pin members 18 to the first and second pin support members 20 and 22, and to efficiently obtain a rotational output which is applied to the output member 66.

Further, since both ends of the pin members 18 are supported by the first and second pin support members 20 and 22, the displacement of the pin members 18 is stably generated in response to an input from the wave generator 16 or the like, and thus stabilization of operation is achieved.

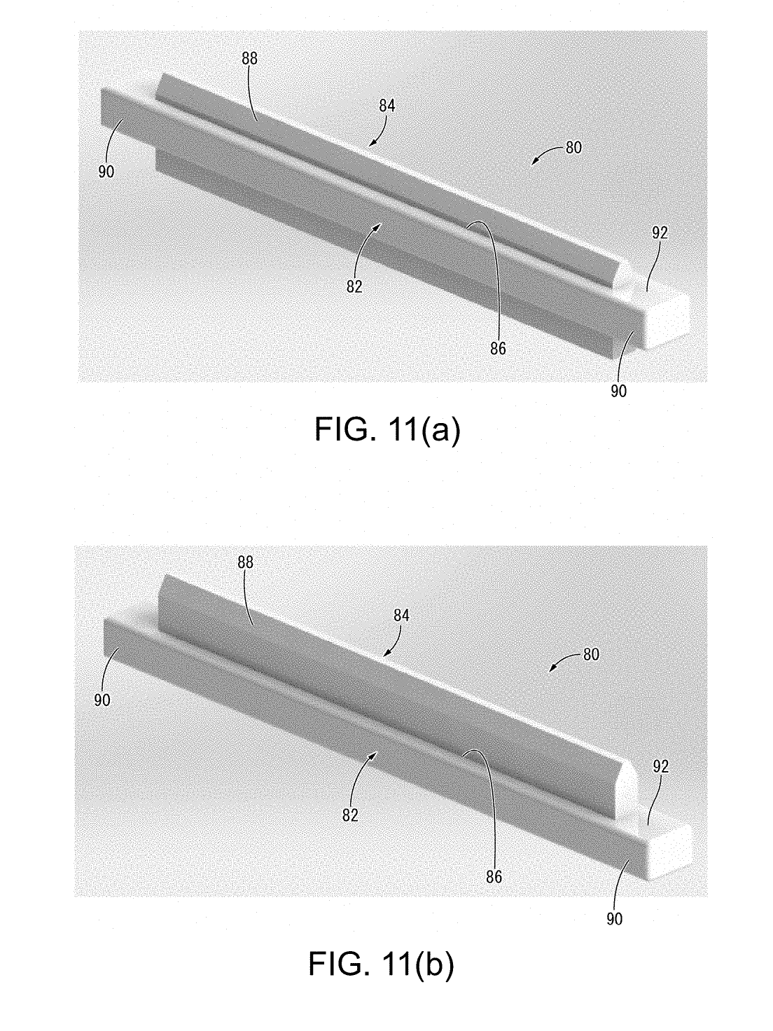

FIG. 11(a) and FIG. 11(b) illustrate a pin member 80 constituting a flex spline of a strain wave gear device according to a second embodiment of the disclosure. The pin member 80 includes a connecting shaft portion 82 that is fixed to the first in support member and a second pin support member which are not illustrated and an external teeth portion 84 that penetrates an intermediate portion in the axial direction of the connecting shaft portion 82 in a direction perpendicular to the axial direction.

More specifically, the connecting shaft portion 82 is a hard member having a substantially rectangular rod shape, and a section hole 86 that penetrates in the radial direction of the flex spline is formed in an intermediate portion in the longitudinal direction. On the other hand, the external teeth portion 84 is a rod-shaped member having a shape corresponding to the insertion hole 86 of the connecting shaft portion 82, and an end located on the outer circumference side of the flex spline has a taper portion 88 of which the width decreases gradually toward the outer circumference of the flex spline.

And, the pin member 80 according to this embodiment is constituted by inserting the external teeth portion 84 into the insertion hole 86 of the connecting shaft portion 82 in the radial direction of the flex spline. The external teeth portion 84 is inserted into the insertion hole 86 of the connecting shaft portion 82 in a non-secured manner, and can be displaced relative to the connecting shaft portion 82 as illustrated in FIG. 11(a) and FIG. 11(b).

Both ends 90 and 90 of the connecting shaft portion 82 of the pin member 80 having the above-mentioned structure are supported by the first and second pin support members having an annular shape which are not illustrated, and a plurality of pin members 80 are arranged in the circumferential direction to constitute a cylindrical part.

Further, both ends 90 and 90 of the connecting shaft portion 82 are fixed to the first and second pin support members by means such as bonding, bolt fixation, or mechanical engagement, and a relative displacement of the connecting shaft portion 82 with respect to the first and second pin support members is prevented.

And, the connecting shaft portion 82 is disposed such that the insertion hole 86 penetrates in the radial direction of the cylindrical part, and the external teeth portion 84 is inserted into the insertion hole 86 of the connecting shaft portion 82 in the radial direction of the cylindrical part. Further, the external teeth portion 84 is disposed such that the taper portion 88 is located on the outer circumference side of the cylindrical part, and an end surface of the external teeth portion 84 located on the inner circumference side of the cylindrical part comes in contact with the outer circumferential surface of a wave generator which is not illustrated by externally fitting an elastic retainer member 42 as a retaining device to the external teeth portion 84 in the same way as in the first embodiment.

And, a protruding length of the external teeth portion 84 from a surface 92 of the connecting shaft portion 82 is set to be small in a state in which the external teeth portion 84 comes in contact with the outer circumferential surface of a short axis portion of the wave generator, as illustrated in FIG. 11(a). Accordingly, the taper portion 88 of the external teeth portion 84 is separated toward the inner circumference from internal teeth of a circular spline which is not illustrated, and thus engagement between the external teeth portion 84 constituting the external teeth of the flex spline and the internal teeth of the circular spline is avoided.

On the other hand, the protruding length of the external teeth portion 84 from the surface 92 of the connecting shaft portion 82 in a state in which the external teeth portion 84 comes in contact with the outer circumferential surface of a long axis portion of the wave generator is set to be large as illustrated in FIG. 11(b), and the taper portion 88 of the external teeth portion 84 engages with the internal teeth of the circular spline which is not illustrated. Accordingly, since a rotational output is generated between the flex spline and the circular spline, an input to the wave generator is reduced and is extracted from the flex spline or the circular spline.

In this way, the first and second pine support members do not need to be attached such that relative displacement of the pin members is permitted, and the first and second pin support members may be fixed to the pin members. And, in this embodiment, the connecting shaft portion 82 is separate from the first and second pin support members, but may be integrally formed with at least one of the first and second pin support members.

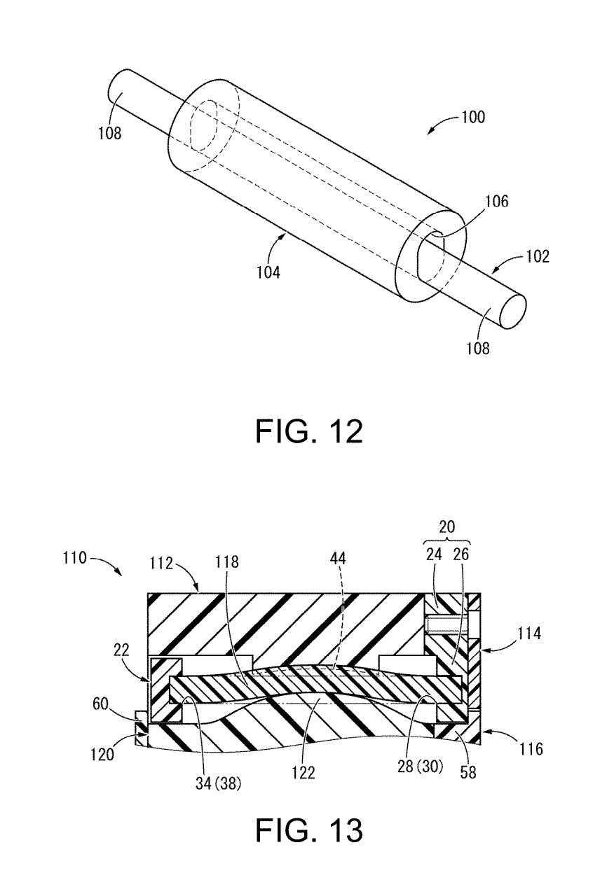

FIG. 12 illustrates a pin member 100 constituting a flex spline of a strain wave gear device according to a third embodiment of the disclosure. The pin member 100 has a structure in which an external teeth portion 104 is externally fitted to a connecting shaft portion 102 having a circular rod shape with a small diameter.

The external teeth portion 104 is formed of a hard synthetic resin or metal or the like, has a substantially columnar shape, and includes an insertion hole 106 into which the connecting shaft portion 102 is inserted. The insertion hole 106 penetrates a substantially constant long circular cross-section in the axial direction, the inner diameter in the short axis direction is set to be substantially equal to or slightly greater than the outer diameter of the connecting shaft portion 102, and the inner diameter in the long axis direction is set to be greater than the outer diameter of the connecting shaft portion 102. Accordingly, a relative displacement of the external teeth portion 104 with respect to the connecting shaft portion 102 in the short axis direction of the insertion hole 106 is limited, and the relative displacement of the external teeth portion 104 with respect to the connecting shaft portion 102 in the long axis direction of the insertion hole 106 is allowed to be greater than that in the short axis direction of the insertion hole 106.

And, a cylindrical part is constituted by a plurality of pin members 100 by fixing both ends 108 and 108 of the connecting shaft portion 102 of each pin member 100 to the first and second pin support members and arranging a plurality of pin members 100 in a cylindrical shape. In this way, a flex spline according to this embodiment is constituted by attaching a plurality of pin members 100 to the first and second pin support members. Further, the external teeth of the flex spline are formed by the external teeth portions 104 of the pin members 100, and an elastic retainer member 42 as a retaining device is externally fitted to the external teeth portion 104 in the same way as in the first embodiment.

In the flex spline having the above-mentioned structure, the external teeth portion 104 constituting the external teeth is movable relative to the connecting shaft portion 102 in the radial direction. Accordingly, a wave generator (not illustrated) which is inserted into the cylindrical part of the flex spline partially presses the external teeth portion 104 to the outer side in the radial direction in the circumferential direction of the cylindrical part, whereby the pressed external teeth portion 104 moves to the outer side in the radial direction relative to the connecting shaft portion 102, and the cylindrical part is partially pressed and expanded to the outer circumference in the circumferential direction by the wave generator.

In the strain wave gear device including the pin member 100 having such a structure according to this embodiment, it is possible to realize stable support of the pin member 100 by fixing both ends of the connecting shaft portion 102 to the first and second pin support members, and it is possible to enable partial engagement between the external teeth of the flex spline and the internal teeth of the circular spline in the circumferential direction by a relative movement of the external teeth portion 104 with respect to the connecting shaft portion 102. And, the cross-sectional shapes of the connecting shaft portion 102 and the external teeth portion 104 are not particularly limited and the cross-sectional shapes may be, for example, polygonal. Further, the hole cross-sectional shape of the insertion hole 106 which is formed in the external teeth portion 104 can be appropriately changed depending on the cross-sectional shape of the connecting shaft portion 102, a required moving distance of the external teeth portion 104 relative to the connecting shaft portion 102, or the like.

FIG. 13 illustrates a part of a strain wave gear device 110 according to a fourth embodiment of the disclosure. The strain wave gear device 110 includes a circular spline 112, a flex spine 114, and a wave generator 116. And, in the following description, members and portions which are ascertained to be substantially the same as in the first embodiment will be referred to by the same reference signs, and description thereof will not be repeated.

More specifically, the circular spline 112 is a hard member having a cylindrical shape with a large diameter as a whole, and internal teeth 44 are formed in an intermediate portion in the axial direction.

The flex spine 114 has a structure in which both ends of each of pin members 118 which are arranged in a cylindrical shape are supported by a first pin support member 20 and a second pin support member 22. In each pin member 118, both ends thereof are inserted into a first pin-insertion recessed portion 28 of the first pin support member 20 and a second pin-insertion recessed portion 34 of the second pin support member 22, and both ends are fixed to the first and second pin support members 20 and 22. The first and second pin-insertion recessed portions 28 and 34 include a cross-section with the substantially same shape and size as the cross-section of the pin member 118, and have a circular cross-section in this embodiment.

Further, each pin member 118 can cause elastic deformation in response to an input in a direction perpendicular to the axial direction. And, the magnitude of bending deformation of the pin members 118 in response to an input is set such that the pin members 118 are curved and pressed and expanded to the outer circumference to engage with the internal teeth 44 of the circular spline 112, when there is an input from the wave generator 116 which will be described later in the direction perpendicular to the axial direction, and the engagement between the pin members 118 and the internal teeth 44 is released in a state in which the input from the wave generator 116 is released.

The wave generator 116 includes a pressing cylindrical member 120. The pressing cylindrical member 120 has a substantially cylindrical shape as a whole, and contact protrusions 122 and 122 that protrude to both sides in the radial direction are formed in an intermediate portion in the axial direction. The contact protrusion 122 has a gently sloped mountain shape which is convex to the outer circumference, and is formed at two positions in the circumferential direction of the pressing cylindrical member 120. Accordingly, the number of lobes of the wave generator 116 in this embodiment is set to two. And, similarly to the wave generator 16 according to the first embodiment, the wave generator 116 is connected to a rotation shaft of an electric motor which is not illustrated, and rotates in the circumferential direction with a rotational driving force of the electric motor.

And, the cylindrical part 40 and the second pin support member 22 of the flex spine 114 are inserted into the inner circumference of the circular spline 112, and the wave generator 116 is inserted into the inner circumference of the flex spine 114.

In the strain wave gear device 110 having the above-mentioned structure, the contact protrusions 122 and 122 of the pressing cylindrical member 120 in the wave generator 116 are partially pressed against an intermediate portion in the axial direction of the cylindrical part 40 in the flex spine 114 in the circumferential direction. Accordingly, since the intermediate portion in the axial direction of each pin member 118 is pressed and expanded toward the outer circumference due to bending deformation, the intermediate portion in the axial direction of the pin member 118 is pressed and expanded to the outer circumference and engages with the internal teeth 44 of the circular spline 112.

On the other hand, since the outer circumferential surface of the pressing cylindrical member 120 is separated from the pin members 118 toward the inner circumference in a part departing from the contact protrusions 122 and 122 in the pressing cylindrical member 120 of the wave generator 116 in the circumferential direction, the pin members 118 are straightly stretched as indicated by an alternate long and two short dashes line in FIG. 13, and the pin members 118 and the internal teeth 44 of the circular spline 112 are separated from each other in the radial direction so as not to engage with each other. That is, in this embodiment, it is not necessarily to provide a retaining device (the elastic retainer member 42) which is separated from the pin members 118, and the pin members 118 which are elastically deformable may be provided to also serve as the retaining device.

As in the strain wave gear device 110 according to this embodiment, the engagement between the external teeth of the flex spline 114 and the internal teeth 44 of the circular spline 112 may be caused by elastic deformation of the pin members 118. According to this configuration, it is possible to employ pin members 118 having a simpler structure and to realize stable support of the pin members 118 by fixing the pin members 118 to the first and second pin support members 20 and 22.

While embodiments of the disclosure have been described above in detail, the disclosure is not limited to the specific descriptions thereof. For example, each pin member is not limited to a columnar shape, but may have a shape having a noncircular cross-section such as a polygonal prism shape. And, the attachment structure of the pin members in the first and second pin support members, the shape of the internal teeth 44 of the circular spline 14, or the like can be appropriately changed depending on the shape of the pin member.

And, the number of pin members 18 constituting the external teeth, the number of internal teeth 44, and a difference between the numbers can be appropriately changed depending on the number of lobes of the wave generator 16, a required reduction ratio, or the like.

The specific structure of the elastic retainer member is not limited to a ring shape which is externally fitted to the cylindrical part 40 in the above-mentioned embodiments. That is, an elastic retainer member may be disposed between the inner circumferential surface of the first and second pin-insertion recessed portions 28 and 34 of the first and second pin support members 20 and 22 and the outer circumferential surface of the pin member 18, which may be realized, for example, by covering the outer circumferential surfaces of both ends of each pin member 18 with a rubber layer as well as covering the inner circumferential surfaces of the first and second pin-insertion recessed portions 28 and 34 with a rubber layer.

Moreover, the retaining device that retains the pin members 18 on the outer circumferential surface of the wave generator 16 is not limited to the elasticity of the member, and, for example, a magnetic attraction force may be made to act between the outer circumferential surface of the wave generator 16 and the pin members 18 such that the pin member 18 is attracted and retained to the outer circumferential surface of the wave generator 16.

In the above-mentioned embodiments, the flex spline 12 is formed of a resin, but the material of the flex spline 12 is not particularly limited and may be formed of a metal such as iron or an aluminum alloy. That is, the materials of the pin members 18 and first and second pin support members 20 and 22 constituting the flex spine 12 are not limited, and can be formed of various materials such as a synthetic resin or a metal.

And, the wave generator 16 may employ, for example, a structure in which a cam plate with an elliptical plate shape is disposed on an inner circumference of a ball bearing including a flexible inner ring and a flexible outer ring, and the cam plate is fixed to the inner ring of the ball bearing. When such a structure in which the ball bearing is disposed is employed, it is possible to curb deterioration in power transmission efficiency due to friction between the wave generator 16 and the flex spline 12. Further, the number of lobes of the wave generator 16 may be set to three or more, and a difference in the number of teeth between the external teeth 18 and the internal teeth 44 is generally set to an integer multiple of the number of lobes.

And, in the above-mentioned embodiment, the securing member 64 is attached to the circular spline 14 such that the circular spline 14 is fixed in a non-rotatable manner, and the output member 66 is attached to the flex spline 12 such that rotation of the flex spline 12 is extracted as an output, but the securing member 64 may be attached to the flex spine 12 such that the flex spine 12 is secured in a non-rotatable manner and the output member 66 may be attached to the circular spline 14 such that rotation of the circular spline 14 is extracted as an output.

1. A flex spline for a strain wave gear device, comprising:
a cylindrical part that is inserted into a circular spline with an annular shape, and the circular spline having a plurality of internal teeth arranged in a circumferential direction on an internal circumferential surface of the circular spline,
a plurality of external teeth are arranged in the circumferential direction and formed on an outer circumferential surface of the cylindrical part, and a number of the external teeth being different from a number of the internal teeth,
the cylindrical part is partially pressed and expanded toward an outer circumference in the circumferential direction by a wave generator which is inserted into the cylindrical part, such that the external teeth of the cylindrical part partially engage with the internal teeth of the circular spline in the circumferential direction,
wherein
the cylindrical part provided with the external teeth comprises a plurality of pin members that are arranged in the circumferential direction, and a retaining device is provided to retain the pin members on an outer circumferential surface of the wave generator, the cylindrical part is partially pressed and expanded toward the outer circumference in the circumferential direction by the wave generator such that the pin members engage with the internal teeth of the circular spline, and the pin members in another part in the circumferential direction of the cylindrical part do not engage with the internal teeth of the circular spline and are retained at positions separated toward an inner circumference by the retaining device,
a first pin support member and a second pin support member that support ends on both sides of the plurality of pin members are provided, and
one of an output member that rotates along with the flex spline and a securing member that inhibits rotation of the flex spline is attached to at least one of the first pin support member and the second pin support member.

2. The flex spline for the strain wave gear device according to claim 1, wherein
a pin-insertion recessed portion that is open at an opposing surface is formed in the first pin support member and the second pin support member which are arranged to face each other in an axial direction of the pin members,
both ends of each pin member are inserted into the pin-insertion recessed portion of the first pin support member and the pin-insertion recessed portion of the second pin support member,
both ends of each pin member are locked with respect to inner circumferential surfaces of the pin-insertion recessed portions in the circumferential direction of the cylindrical part, and
both ends of each pin member is allowed to move in a radial direction of the cylindrical part in the pin-insertion recessed portions.

3. The flex spline for the strain wave gear device according to claim 2, wherein
the pin-insertion recessed portions are formed to be continuous in the circumferential direction of the cylindrical part,
a deep portion and a shallow portion are disposed in each pin-insertion recessed portion,
the deep portion of the pin-insertion recessed portion in the first pin support member and the shallow portion of the pin-insertion recessed portion in the second pin support member face each other in the axial direction,
the shallow portion of the pin-insertion recessed portion in the first pin support member and the deep portion of the pin-insertion recessed portion in the second pin support member face each other in the axial direction.

4. The flex spline for the strain wave gear device according to claim 1, wherein
the retaining device that elastically retains the pin members on the outer circumferential surface of the wave generator is formed in an annular shape, and
the retaining device is externally fitted to the cylindrical part including the plurality of pin members.

5. The flex spline for the strain wave gear device according to claim 1, wherein
the pin members and at least one of the first pin support member and the second pin support member are formed of a synthetic resin.

6. The flex spline for the strain wave gear device according to claim 1, wherein
both of the first pin support member and the second pin support member are attached to one of the output member that rotates along with the flex spline and the securing member that inhibits rotation of the flex spline.

7. A strain wave gear device, comprising:
a circular spline with an annular shape in which internal teeth are formed on an inner circumferential surface of the circular spline,
a cylindrical part of a flex spline inserted into an inner circumference of the circular spline,
external teeth, formed on an outer circumferential surface of the cylindrical part of the flex spline, and a number of the external teeth being different from a number of the internal teeth of the circular spline,
a wave generator inserted into an inner circumference of the flex spline, the cylindrical part of the flex spline is partially pressed and expanded toward the outer circumference in the circumferential direction by the wave generator such that the external teeth of a part pressed and expanded by the wave generator engage with the internal teeth of the circular spline,
wherein the flex spline according to claim 1 is used as the flex spline.
